(19) United States
(12) Patent Application Publication
(10) Pub. No.: US 2013/0092403 A1
(43) Pub. Date: Apr. 18, 2013

(54) FIRE FIGHTING DEVICE

(71) Applicant: Paolo Amadesi, Bologna (IT)

(72) Inventor: Paolo Amadesi, Bologna (IT)

(73) Assignee: EMILSIDER MECCANICA S.P.A., Granarolo Dell'emilia (BO) (IT)

(21) Appl. No.: 13/638,427

(22) PCT Filed: Apr. 1, 2011
(86) PCT No.: PCT/IB2011/000712

§ 371 Date: Dec. 17, 2012

(30) Foreign Application Priority Data
Apr. 1, 2010 (IT) BO2010A000199

(51) Int. Cl. A62C 37/48

(52) U.S. Cl. CPC A62C 37/48
USPC 169/57

(57) ABSTRACT

A fire fighting device having a probe for monitoring the temperature in a fire-risk area; a tank for supplying an extinguishing substance; and a dispenser for feeding the extinguishing substance from the tank to the fire-risk area; the fire fighting device also having a control connecting the probe to the tank, and which produces a chemical reaction inside the tank.

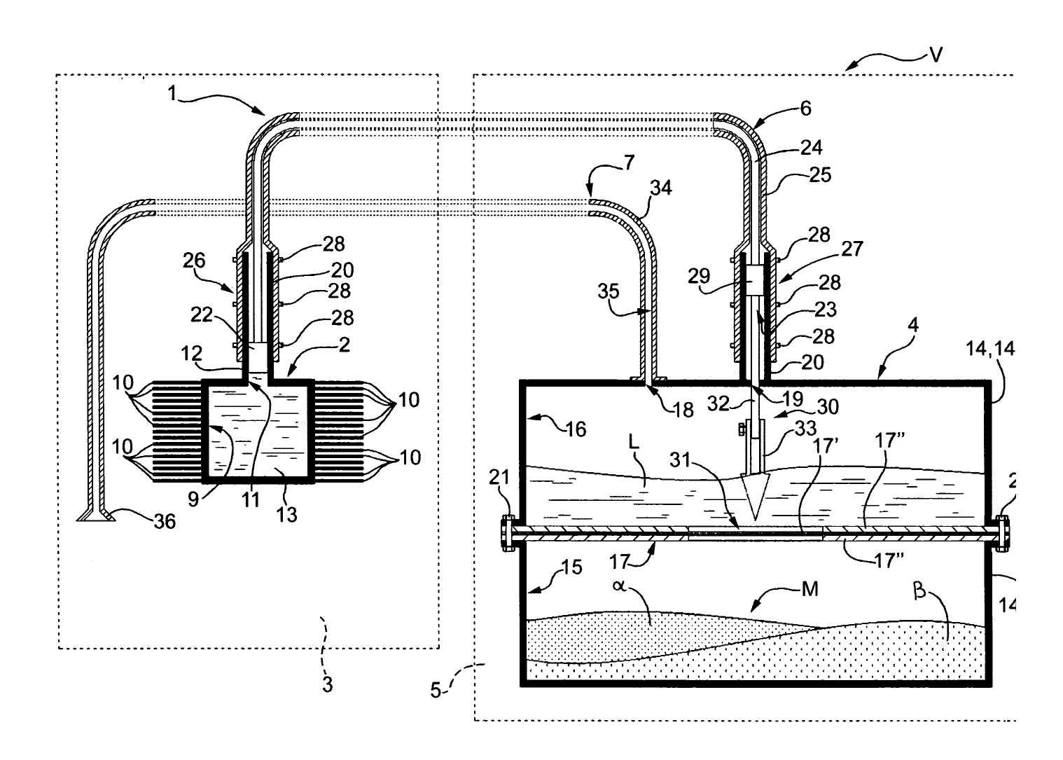

### TECHNICAL FIELD

The present invention relates to a fire fighting device.

More specifically, the present invention relates to a fire fighting device for controlling and extinguishing a fire in a first area by suffocating it with an inert gas produced in a second area isolated thermally from the first area.

### BACKGROUND ART

A fire fighting system is known comprising an area monitoring probe; a remote tank containing an extinguishing substance; and a pumping system for feeding the extinguishing substance from the tank to the controlled area in the event of a fire.

Systems of the above type have the drawback of being complicated, bulky and heavy; comprising electrically operated parts; being unsuitable for extinguishing sudden fires with a sharp rise in temperature; and only operating for a limited length of time, often not long enough to completely cool the embers, which may therefore flare up again once the initial atmosphere is restored. Moreover, systems employing extinguishing gas are equipped with complex, high-cost tanks designed to withstand internal pressure to avoid gas leakage, and cannot be relied on to operate in the absence of electric power.

Systems of the above type are therefore unsuitable for small environments not connected to an electricity source, such as a vehicle, e.g. a car, in which space and electric power are limited.

### DISCLOSURE OF INVENTION

It is an object of the present invention to provide a fire fighting device designed to eliminate the above drawbacks.

According to the present invention, there is provided a fire fighting device as claimed in claim 1 and preferably in any one of the following Claims depending directly or indirectly on claim 1.

According to the present invention, there is also provided a vehicle as claimed in claim 10.

### BRIEF DESCRIPTION OF THE DRAWING

A non-limiting embodiment of the invention will be described by way of example with reference to the attached drawing, which shows a section of a preferred embodiment of the fire fighting device according to the present invention.

### BEST MODE FOR CARRYING OUT THE INVENTION

The letter V in the attached drawing indicates a vehicle comprising a fire fighting device 1, and having a fire-risk area 3, and an area 5 remote from area 3.

Fire fighting device 1 comprises a probe 2 for detecting the temperature in fire-risk area 3; a tank 4 housed in area 5 and for generating an extinguishing gas, as explained in detail below; a control 6 connecting probe 2 and tank 4; and a dispenser 7 connected to tank 4 to feed the extinguishing gas produced in tank 4 into area 3 in the event of a fire.

Probe 2 comprises a box body, which has an inner cavity 9, and a number of fins 10 covering the outside of the box body to maximize heat exchange between area 3 and cavity 9.

The box body is made of metal, and fins 10 are also made of high heat-transmitting material, such as metal. For example, both the box body and fins 10 are made of aluminium.

The Box body has an opening 11 connecting cavity 9 to the outside, and which, as shown in the drawing, faces the inside of a tubular body 12 of probe 2.

Cavity 9 of probe 2 contains a liquid 13 with a high coefficient of thermal expansion and containing, for example, glycerin.

Tank 4 comprises a box body 14, in which are formed a cavity 15 for powdered material; a cavity 16 for liquid material; and a partition 17 separating cavities 15 and 16 and having a very thin sheet 17′ (i.e. with a very small thickness-area ratio) of metal, such as aluminium.

Tank 4 has an opening 18 connecting dispenser 7 to cavity 16; and an opening 19 connecting control 6 to cavity 16.

Cavity 16 is designed to only allow outflow of gaseous substances through opening 18. More specifically, cavity 16 is of such a volume as to prevent outflow of liquid, and/or comprises known members (not shown) for protecting, and preventing liquid outflow through, opening 18.

As shown in the drawing, opening 19 faces the inside of a tubular body 20 of tank 4.

As shown in the drawing, tank 4 comprises two cup-shaped bodies 14a, 14b positioned with their concavities facing, and connected, e.g. by bolts 21, along respective mating flanges to grip partition 17 and so fix it to body 14.

As shown in the drawing, partition 17 comprises sheet 17′; and a number of supports 17″ fitted to opposite faces of sheet 17′ to seal tank 4 and separate cavities 15 and 16 hermetically.

Sheet 17 is made of metal, such as aluminium.

Control 6 comprises a regulator 22 communicating with liquid 13 in probe 2; an actuator 23 designed to break partition 17 in tank 4 to mix the content of cavity 15 with the content of cavity 16; a transmission 24 between regulator 22 and actuator 23; and a sheath 25 between probe 2 and tank 4, and comprising a tubular body with a connection 26 to probe 2, and a connection 27 to tank 4.

As shown in the drawing, connections 26 and 27 are fitted to tubular body 12 of probe 2 and tubular body 20 of tank 4 respectively by means of at least one fastener 28.

Sheath 25 at least partly houses the assembly comprising regulator 22, actuator 23, and transmission 24; and transmission 24 comprises a cable made of music wire or comprising, for example, a flexible steel braid.

As shown in the drawing, regulator 22 is housed inside tubular body 12, and more specifically is fitted in fluidtight manner inside tubular body 12, slides axially along tubular body 12, and is movable from a rest position (shown in the drawing) to a work position (not shown).

Similarly, actuator 23 is fitted in fluidtight manner inside tubular body 20, slides axially along tubular body 20, and in turn comprises a piston 29 fitted in fluidtight manner inside tubular body 20; and a piercing member 30 projecting from piston 29 into cavity 16 of the tank and facing partition 17. Actuator 23 is movable from a rest position (shown in the drawing) to a work position (not shown) in which piercing member 30 pierces through partition 17.

Partition 17 preferably comprises a weakened portion 31 facing piercing member 30 to facilitate piercing of partition 17 by piercing member 30.

As shown in the drawing, piercing member 30 comprises a rod 32 connected to the free end of piston 29 and coaxial with tubular body 20; and a tip 33, which is connected to the free end of rod 32, projects inside cavity 16, and is slidable along at least a portion of rod 32 to adjust its position along rod 32 and the gap between tip 33 and partition 17.

The length of tubular body 12 and tubular body 20 determines the operating temperature range of fire fighting device 1.

The distance between tip 33 and partition 17 determines the activation temperature of fire fighting device 1. More specifically, tip 33 can be positioned facing partition 17 to set the reaction temperature of fire fighting device 1 to an ambient temperature ranging between 70 and 160° C., depending on the area monitored by probe 2.

Dispenser 7 comprises a tubular body 34 with a conduit 35 facing opening 18 in the tank; and a nozzle 36 located inside area 3.

As shown in the drawing, cavity 15 contains a mixture M of powdered chemical reagents which react in contact with liquid. For example, mixture M comprises a quantity of a powdered substance α of NaHCO₃ (sodium bicarbonate) and a quantity of a powdered substance β of C₆H₈O₇ (citric acid). A kilogram of mixture M, in contact with liquid, produces 100-200 normal litres [NL] of extinguishing gas. More specifically, mixture M produces CO₂ (carbon dioxide) in contact with liquid.

The quantity of powdered substance α of NaHCO₃ in mixture M is preferably 1 to 1.5 times the quantity of powdered substance β of C₆H₈O₇.

Alternatively, Na₂CO₃ (sodium carbonate) or K₂CO₃ (potassium carbonate) or KHCO₃ (potassium bicarbonate) may be substituted for NaHCO₃ (sodium bicarbonate) as powdered substance α; and C₄H₆O₆ (tartaric acid) or HOOCCH(OH)CH₂COOH (malic acid) or weak acids may be substituted for C₆H₈O₇ (citric acid) as powdered substance β. In other words, powdered substance a is selected from a group comprising NaHCO₃, K₂CO₃ and KHCO₃, and powdered substance β is selected from a group comprising C₆H₈O₇, C₄H₆O₆ and HOOCCH (OH) CH₂COOH.

Tank 4 is preferably designed to contain enough mixture M to produce 0.1 to 30 Nm³ of CO₂.

Cavity 16 contains a liquid L, e.g. distilled water, preferably of a mass equal to 20-35% of the mass of mixture M.

The mass ratios of powdered substances α, β, and liquid L are such that production of CO₂ is gradual, decreases exponentially, and is effective for at least 150 seconds, i.e. long enough to cool embers and prevent them from flaring up again when normal atmospheric conditions are restored. For example, if α is K₂CO₃ (potassium carbonate), β is C₆H₈O₇ (citric acid), and liquid L is H₂O (water), the maximum ratios are 1.5:1:0.5.

Roughly speaking, the quantity of powdered substance α is 1 to 1.5 times the quantity of powdered substance β. Powdered substances α and β and liquid L are preferably stoichiometrically related.

In a variation not shown, cavity 15 contains only one powdered reagent, and cavity 16 contains a saturated solution of distilled water and another reagent. In this case, too, the reagent-liquid proportions indicated above may also be applied.

Fire fighting device 1 operates as follows.

When installing fire fighting device 1, probe 2 is installed in a fire-risk area 3 for monitoring, and tank 4 is installed, for example, in a non-risk area 5.

As the temperature in area 3 rises, liquid 13 in probe 2 expands and pushes regulator 22 along tubular body 12.

By means of transmission 24, displacement of regulator 22 displaces actuator 23. In this connection, it is important to note that, using liquid 13 to monitor the temperature in area 3 and control displacement of regulator 22 and, hence, of actuator 23 by means of transmission 24, fire fighting device 1 can be operated independently, with no need for electric power or any external power source. Also, the coefficient of thermal expansion of a liquid 13 containing glycerin is sufficient to produce the requirement movements of actuator 23, depending on the size of probe 2 and regulator 22, and the temperature threshold above which probe 2 activates fire fighting device 1. It should be noted, in fact, that actuator 23 is designed to pierce partition 17 at a given temperature.

When the given temperature is reached in area 3, actuator 23 pierces partition 17, so liquid L flows from cavity 16 into cavity 15, thus activating a chemical reaction in cavity 15.

The chemical reaction produces an extinguishing gas, which flows out of tank 4 through opening 18 into conduit 35, and is fed into area 3 by dispenser 7.

Fire fighting device 1 is therefore cheap and easy to produce, and requires no electronic equipment. The mass ratio of the reagents (liquid L and the substances in mixture M) produces effective CO₂ for at least 150 seconds, to ensure thorough cooling of the embers and prevent them from flaring up again when normal atmospheric conditions are restored. Being compact and lightweight, fire fighting device 1 described can be installed on motor vehicles to control and prevent fires, especially in the engine area or trailers. Appropriately sized, fire fighting device 1 may also be installed in closed environments, such as libraries or similar. And finally, fire fighting device 1 is activated automatically, with no electric power required.

1. A fire fighting device comprising a probe for monitoring the temperature in a fire-risk area; a tank for supplying an extinguishing substance; and a dispenser for feeding the extinguishing substance from the tank to the fire-risk area; the fire fighting device wherein a control connects the probe to the tank, and produces a chemical reaction inside the tank.

2. A fire fighting device as claimed in claim 1, wherein the probe comprises a cavity containing a heat-expanding substance communicating with the control.

3. A fire fighting device as claimed in claim 2, wherein the probe contains a liquid, in particular glycerin.

4. A fire fighting device as claimed in claim 1, wherein the tank comprises a number of compartments, each containing at least one chemical substance; the chemical reaction produced by mixing said chemical substances produces an extinguishing substance; said compartments are separated by a partition; and the control ruptures said partition when a given temperature in the fire-risk area is reached.

5. A fire fighting device as claimed in claim 4, wherein the control comprises a regulator communicating with the heat-expanding substance; an actuator facing the partition; and a transmission connecting the regulator to the actuator; and wherein, in the event of a fire in the fire-risk area, the regulator is displaced and ruptures the partition by pushing the actuator against the partition.

6. A fire fighting device as claimed in claim 4, wherein the tank comprises a first compartment containing a powdered substance; and a second compartment containing a liquid substance.

7. A fire fighting device as claimed in claim 6, wherein the first compartment contains a mixture of a first powdered substance and a second powdered substance; the first powdered substance is selected from a group of powdered substances comprising NaHCO₃, K₂CO₃ and KHCO₃; and the second powdered substance is selected from a group of powdered substances comprising C₆H₈O₇, C₄H₆O₆ and HOOCCH(OH)CH₂COOH.

8. A fire fighting device as claimed in claim 7, wherein the quantity of the first powdered substance is 1 to 1.5 times the quantity of the second powdered substance.

9. A fire fighting device as claimed in claim 6, wherein the mass of liquid in the second compartment is 20-35% of the mass of powdered substance in the first compartment.

10. A vehicle comprising a fire fighting device as claimed in claim 1.
